(19) United States
(12) Patent Application Publication
(10) Pub. No.: US 2003/0082083 A1
(43) Pub. Date: May 1, 2003

(54) Portable ozone generating device

(76) Inventor: Yeong-Nian Suen, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/984,094

(22) Filed: Oct. 29, 2001

(51) Int. Cl. B01J 19/08; B01J 19/12

(52) U.S. Cl. 422/186.07

(57) ABSTRACT

A portable ozone generating device includes a base with an integrated circuit board, a first switch member and a second switch member respectively received therein. A set of battery is received in the base and electrically connected to the circuit board. A pivotable member is pivotally connected to the base and a ultra-violet bulb is engaged in the pivotable member. A first control member and a second control member are respectively connected to the pivotable member, and are activated to light up the ultra-violet bulb and the electric shock device on a top of the base when pivoting the pivotable member away from the base at different angles.

### FIELD OF THE INVENTION

The present invention relates to a portable ozone generating device which includes a ultra-violet bulb connected to a pivotable member which is pivoted away from the base to activate the ultra-violet bulb to generate ozone.

### BACKGROUND OF THE INVENTION

A conventional air refreshing device generally includes a fragrant bottle with a nozzle so that the user operates the nozzle to eject refresh fragrant to overcome bad smell in the air. The fragrant cannot last long and the quality of the air is not improved. An air cleaning device usually is a bulky box which is not portable. Some females carry a protection device that has a siren and some of which have electric shock device. However, most of the devices have a bulky outer appearance so that they are not welcomed by the users.

The present invention provides a compact device that has multiple functions and is easily to be carried.

### SUMMARY OF THE INVENTION

In accordance with one aspect of the present invention, there is provided a portable ozone generating device which comprises a base having an open side so that a pivotable member is engaged therewith. An integrated circuit board is received in the base and a first switch member and a second switch member are respectively connected to the circuit board. A set of battery is received in the base and electrically connected to the circuit board. A pivotable member is pivotally connected to the base and a ultra-violet bulb is engaged in the pivotable member. A first control member and a second control member are respectively connected to the pivotable member. The first control member and the second control member are located in alignment with the first switch member and the second switch member respectively so that the first switch member and the second switch member are activated when the first control member and the second control member are shifted away therefrom.

The primary object of the present invention is to provide a device that has a compact size and has a ultra-violet bulb and an electric shock terminals are connected to the top of the base.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the portable ozone generating device of the present invention;

FIG. 2 is an exploded view to show the portable ozone generating device of the present invention;

FIG. 3 is a cross sectional view to show the portable ozone generating device of the present invention;

FIG. 4 is a cross sectional view to show that the pivotable member of the portable ozone generating device is pivoted at an angle from the base of the present invention;

FIG. 5 is a cross sectional view to show that the pivotable member of the portable ozone generating device is pivoted at another angle from the base of the present invention;

FIG. 6 shows that a user's hand pulling off the safety pin and pushing the push button connected to the electric shock switch, and

FIG. 7 shows that the device of the present invention is conveniently put in a holder in cars.

### DETAILED DESCRIPTION OF THE PREFERRED EMBODIMENT

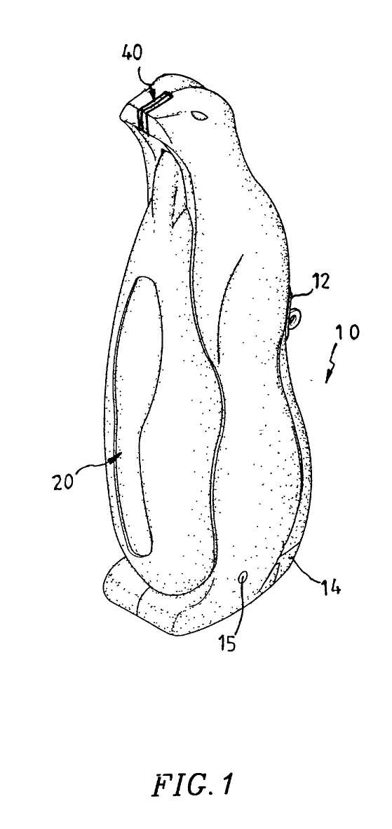

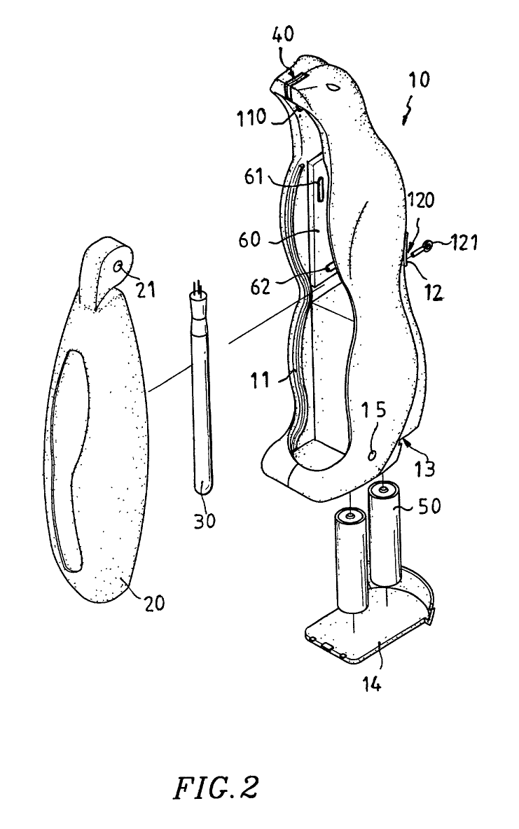

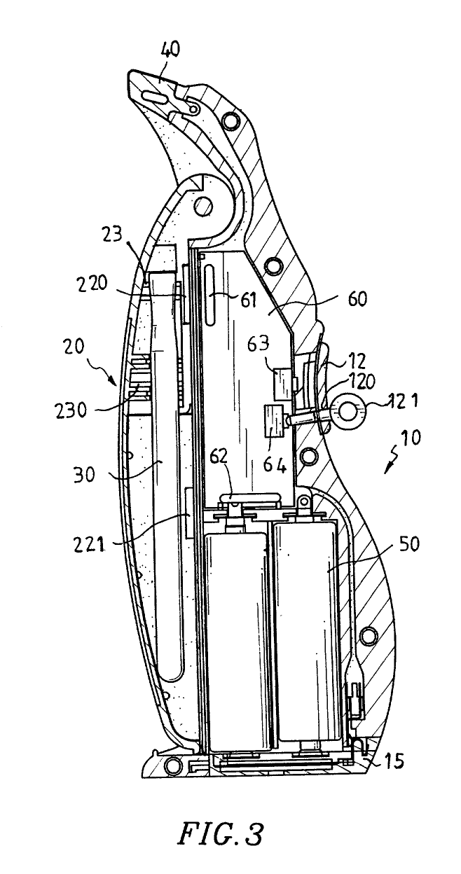

Referring to FIGS. 1 to 3, the portable ozone generating device of the present invention comprises a base 10 having an open side which has a stepped flanges 11 on a periphery of the open side so that a pivotable member 20 can be engaged with the open side by engaging two rods 110 (only one is shown) in the base 10 with two holes 21 on two sides of a top of the pivotable member 20. An integrated circuit board 60 is received in the base 10, and a first switch member 61 and a second switch member 62 are respectively connected to the circuit board 60. A power supply device such as a set of battery 50 is received in the base 10 and electrically connected to the circuit board 60. An end cover 14 seals a bottom of the base 10 and a receptacle 15 is installed to the base 10 so that a DC power supply can also be used to provide electric power to the circuit board 60.

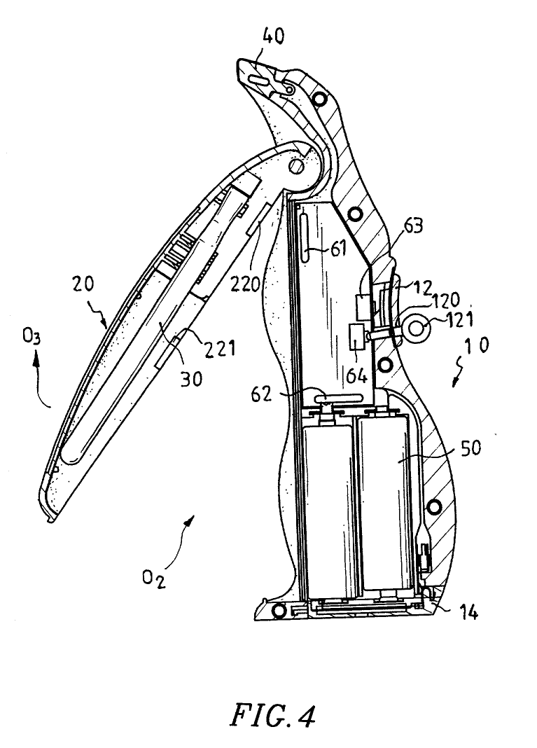

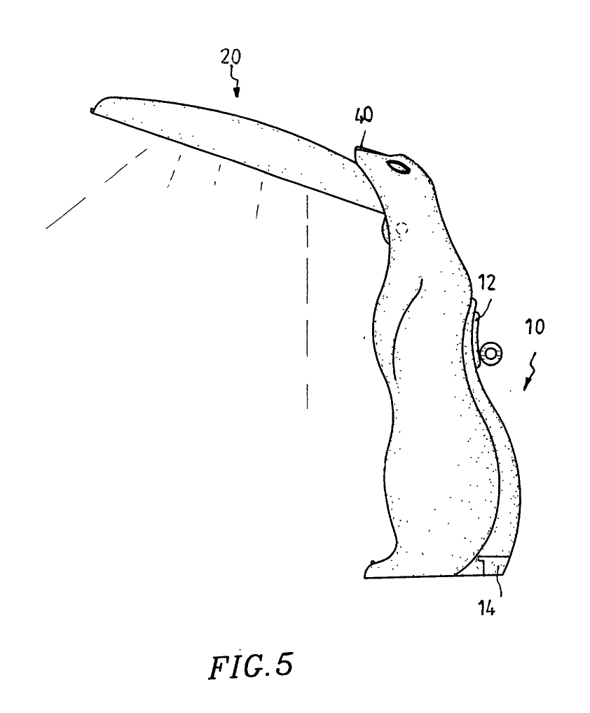

The pivotable member 20 has a ultra-violet bulb 30 engaged in the pivotable member 20. A first control member 220 and a second control member 221 are respectively connected to the pivotable member 20, both of which are permanent magnets. The first control member 220 and the second control member 221 are located in alignment with the first switch member 61 and the second switch member 62 respectively. The first switch member 61 and the second switch member 62 are magnetic switches so that when the pivotable member 20 is pivoted away from the base at an angle as shown in FIG. 4, the second switch member 62 is activated because the second control member 221 is moved too far from the second switch member 62 and has no magnetic relationship existed between them. The ultra-violet bulb 30 then lights up and a long term time counting function goes on. The air existed between the pivotable member 20 and the base 10 is affected by the ultra-violet bulb 30 to be ozone which refreshes the air around the users. As shown in FIG. 5, when the pivotable member 20 is pivoted away from the base 10 at a larger angle as shown, the ultra-violet bulb 30 lights up only a short period of time so that the users may use the ultra-violet bulb 30 to detect fake bills.

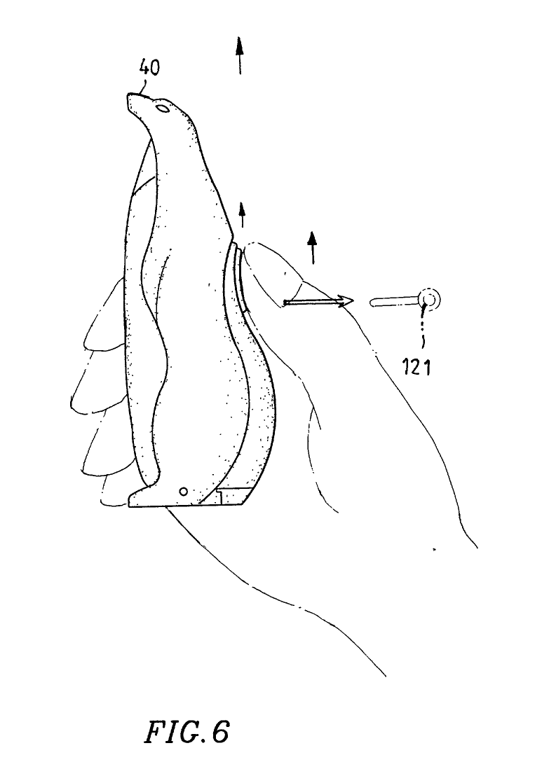

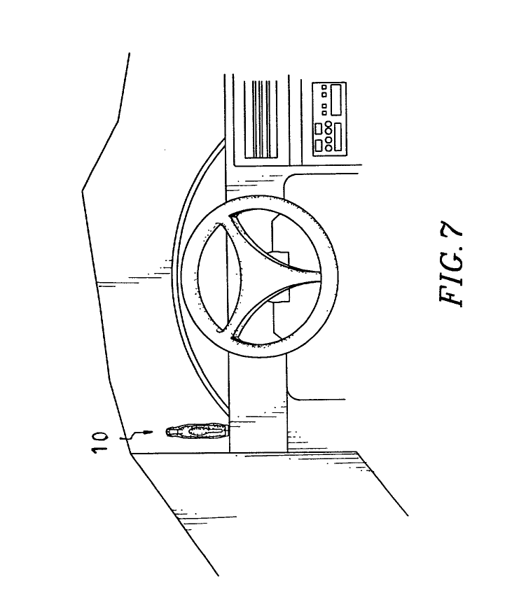

Two electric shock terminals 40 are connected to a top of the base 10 and a siren switch 64 and an electric shock switch 63 are respectively connected in the base 10. A push button 12 is connected to the electric shock switch 63 and located at an outside of the base 10. A safety pin 121 extends through a hole 120 in the push button 12 and connected to the siren switch 64. As shown in FIG. 6, when the safety pin 121 is pulled off, the siren switch 64 is activated and a huge sound siren is sent. A high voltage electric current is generated when pushing the push button 12 upward to protect the users. As shown in FIG. 7, the device is conveniently to be put in a holder on a dashboard of a car.

While we have shown and described the embodiment in accordance with the present invention, it should be clear to those skilled in the art that further embodiments may be made without departing from the scope of the present invention.

What is claimed is:

1. A portable ozone generating device comprising:
a base having an open side and an integrated circuit board received in said base, a first switch member and a second switch member respectively connected to said circuit board, a power supply device received in said base and electrically connected to said circuit board, and
a pivotable member pivotally connected to said base and a ultra-violet bulb engaged in said pivotable member, a first control member and a second control member respectively connected to said pivotable member, said first control member and said second control member located in alignment with said first switch member and said second switch member respectively.

2. The device as claimed in claim 1, wherein said top of said base has two electric shock terminals connected thereto, a siren switch and an electric shock switch respectively connected in said base, a push button connected to said electric shock switch and located at an outside of said base, a safety pin extending through said push button and connected to said siren switch.

3. The device as claimed in claim 1, wherein said first switch member and said second switch member are magnetic switches and said first control member and said second control member are permanent magnets.
